(19) United States
(12) Patent Application Publication
(10) Pub. No.: US 2023/0283605 A1
(43) Pub. Date: Sep. 7, 2023

(54) AUTHENTICATION OF CONSUMER PREMISE EQUIPMENT

(71) Applicant: ARRIS Enterprises LLC, Suwanee, GA (US)

(72) Inventors: Janet T. BEAN, Underhill, VT (US); Christopher W. FOX, Alpharetta, GA (US); Brian W. LANE, Gainesville, GA (US); Kazuhiko TOMOMATSU, Naperville, IL (US); David Franklin BARAN, Haverford, PA (US)

(73) Assignee: ARRIS Enterprises LLC, Suwanee, GA (US)

(21) Appl. No.: 18/116,767

(22) Filed: Mar. 2, 2023

Related U.S. Application Data
(60) Provisional application No. 63/315,798, filed on Mar. 2, 2022.

(51) Int. Cl. H04L 9/40; H04H 20/78

(52) U.S. Cl. CPC H04L 63/0876; H04H 20/78

(57) ABSTRACT

In one embodiment a distribution system includes customer premise equipment that is authenticated to a network that includes a cable modem termination system based upon a DOCSIS authentication. The customer premise equipment receives data from a supplicant device that is interconnected to the network through the customer premise equipment where the supplicant device is authenticated to the network based upon an 802.1X authentication.

### CROSS REFERENCE TO RELATED APPLICATIONS

This application claims the benefit of U.S. Provisional patent Application Ser. No. 63/315,798 filed Mar. 2, 2022.

### BACKGROUND

The subject matter of this application relates to authentication techniques.

Cable Television (CATV) services provide content to large groups of customers (e.g., subscribers) from a central delivery unit, generally referred to as a “head end,” which distributes channels of content to its customers from this central delivery unit through an access network comprising a hybrid fiber coax (HFC) cable plant, including associated components (nodes, amplifiers and taps). Modern Cable Television (CATV) service networks, however, not only provide media content such as television channels and music channels to a customer, but also provide a host of digital communication services such as Internet Service, Video-on-Demand, telephone service such as VoIP, home automation/security, and so forth. These digital communication services, in turn, require not only communication in a downstream direction from the head end, through the HFC, typically forming a branch network and to a customer, but also require communication in an upstream direction from a customer to the head end typically through the HFC network.

To this end, CATV head ends have historically included a separate Cable Modem Termination System (CMTS), used to provide high speed data services, such as cable Internet, Voice over Internet Protocol, etc. to cable customers and a video headend system, used to provide video services, such as broadcast video and video on demand (VOD). Typically, a CMTS will include both Ethernet interfaces (or other more traditional high-speed data interfaces) as well as radio frequency (RF) interfaces so that traffic coming from the Internet can be routed (or bridged) through the Ethernet interface, through the CMTS, and then onto the RF interfaces that are connected to the cable company's hybrid fiber coax (HFC) system. Downstream traffic is delivered from the CMTS to a cable modem and/or set top box in a customer's home, while upstream traffic is delivered from a cable modem and/or set top box in a customer's home to the CMTS. The Video Headend System similarly provides video to either a set-top, TV with a video decryption card, or other device capable of demodulating and decrypting the incoming encrypted video services. Many modern CATV systems have combined the functionality of the CMTS with the video delivery system (e.g., EdgeQAM—quadrature amplitude modulation) in a single platform generally referred to an Integrated CMTS (e.g., Integrated Converged Cable Access Platform (CCAP))—video services are prepared and provided to the I-CCAP which then QAM modulates the video onto the appropriate frequencies. Still other modern CATV systems generally referred to as distributed CMTS (e.g., distributed Converged Cable Access Platform) may include a Remote PHY (or R-PHY) which relocates the physical layer (PHY) of a traditional Integrated CCAP by pushing it to the network's fiber nodes (R-MAC PHY relocates both the MAC and the PHY to the network's nodes). Thus, while the core in the CCAP performs the higher layer processing, the R-PHY device in the remote node converts the downstream data sent from the core from digital-to-analog to be transmitted on radio frequency to the cable modems and/or set top boxes, and converts the upstream radio frequency data sent from the cable modems and/or set top boxes from analog-to-digital format to be transmitted optically to the core.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates an integrated Cable Modem Termination System.

FIG. 2 illustrates a distributed Cable Modem Termination System.

FIG. 3 illustrates authentication using a CMTS and customer premise equipment.

FIG. 4 illustrates authentication of a supplicant client and an authentication server.

FIG. 5 illustrates customer premise equipment interconnected to computing devices and a supplicant client.

FIG. 6 illustrates one embodiment of a network architecture.

FIG. 7 illustrates a flow process for 802.1X authentication for the network architecture of FIG. 6.

FIG. 8 illustrates another embodiment of a network architecture.

FIG. 9 illustrates a flow process for 802.1X authentication for the network architecture of FIG. 8.

### DETAILED DESCRIPTION

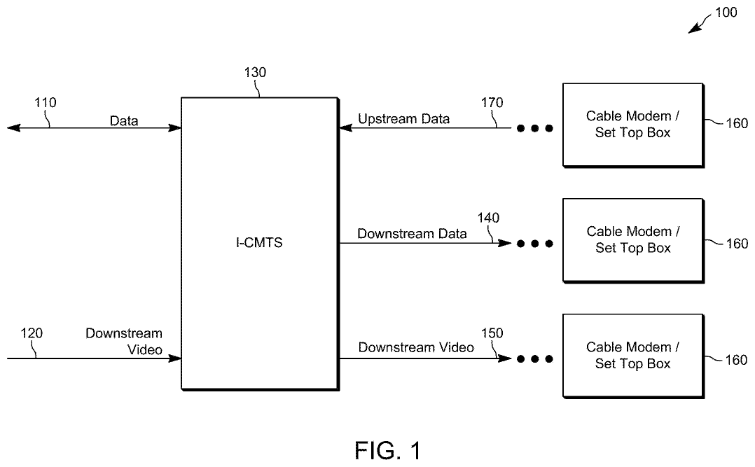

Referring to FIG. 1, an integrated CMTS (e.g., Integrated Converged Cable Access Platform (CCAP)) 100 may include data 110 that is sent and received over the Internet (or other network) typically in the form of packetized data. The integrated CMTS 100 may also receive downstream video 120, typically in the form of packetized data from an operator video aggregation system. By way of example, broadcast video is typically obtained from a satellite delivery system and pre-processed for delivery to the subscriber though the CCAP or video headend system. The integrated CMTS 100 receives and processes the received data 110 and downstream video 120. The CMTS 130 may transmit downstream data 140 and downstream video 150 to a customer's cable modem and/or set top box 160 through a RF distribution network, which may include other devices, such as amplifiers and splitters. The CMTS 130 may receive upstream data 170 from a customer's cable modem and/or set top box 160 through a network, which may include other devices, such as amplifiers and splitters. The CMTS 130 may include multiple devices to achieve its desired capabilities.

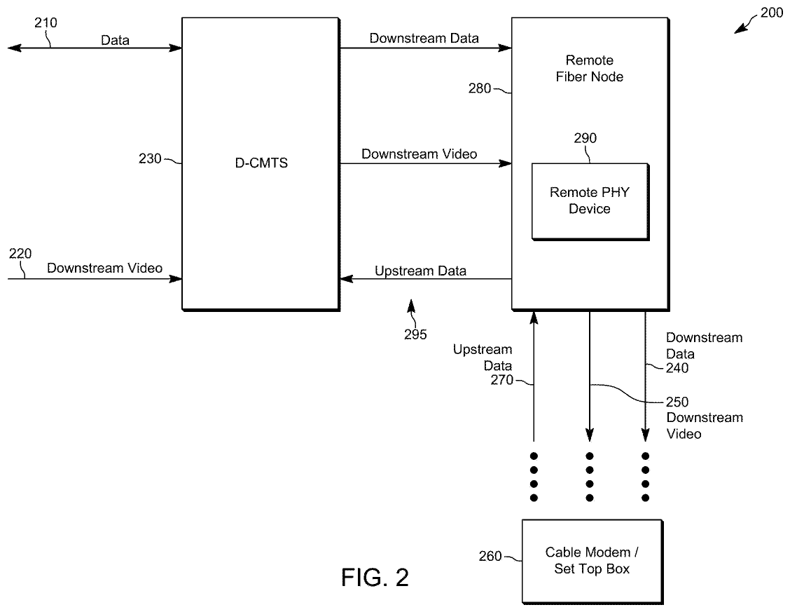

Referring to FIG. 2, as a result of increasing bandwidth demands, limited facility space for integrated CMTSs, and power consumption considerations, it is desirable to include a Distributed Cable Modem Termination System (D-CMTS) 200 (e.g., Distributed Converged Cable Access Platform (CCAP)). In general, the CMTS is focused on data services while the CCAP further includes broadcast video services. The D-CMTS 200 distributes a portion of the functionality of the I-CMTS 100 downstream to a remote location, such as a fiber node, using network packetized data. An exemplary D-CMTS 200 may include a remote PHY architecture, where a remote PHY (R-PHY) is preferably an optical node device that is located at the junction of the fiber and the coaxial. In general the R-PHY often includes the PHY layers of a portion of the system. The D-CMTS 200 may include a D-CMTS 230 (e.g., core) that includes data 210 that is sent and received over the Internet (or other network) typically in the form of packetized data. The D-CMTS 200 may also receive downstream video 220, typically in the form of packetized data from an operator video aggregation system. The D-CMTS 230 receives and processes the received data 210 and downstream video 220. A remote Fiber node 280 preferably include a remote PHY device 290. The remote PHY device 290 may transmit downstream data 240 and downstream video 250 to a customer's cable modem and/or set top box 260 through a network, which may include other devices, such as amplifier and splitters. The remote PHY device 290 may receive upstream data 270 from a customer's cable modem and/or set top box 260 through a network, which may include other devices, such as amplifiers and splitters. The remote PHY device 290 may include multiple devices to achieve its desired capabilities. The remote PHY device 290 primarily includes PHY related circuitry, such as downstream QAM modulators, upstream QAM demodulators, together with psuedowire logic to connect to the D-CMTS 230 using network packetized data. The remote PHY device 290 and the D-CMTS 230 may include data and/or video interconnections, such as downstream data, downstream video, and upstream data 295. It is noted that, in some embodiments, video traffic may go directly to the remote physical device thereby bypassing the D-CMTS 230. In some cases, the remote PHY and/or remote MAC PHY functionality may be provided at the head end.

By way of example, the remote PHY device 290 may covert downstream DOCSIS (i.e., Data Over Cable Service Interface Specification) data (e.g., DOCSIS 1.0; 1.1; 2.0; 3.0; 3.1; and 4.0 each of which are incorporated herein by reference in their entirety), video data, out of band signals received from the D-CMTS 230 to analog for transmission over RF or analog optics. By way of example, the remote PHY device 290 may convert upstream DOCSIS, and out of band signals received from an analog medium, such as RF or linear optics, to digital for transmission to the D-CMTS 230. As it may be observed, depending on the particular configuration, the R-PHY may move all or a portion of the DOCSIS MAC and/or PHY layers down to the fiber node.

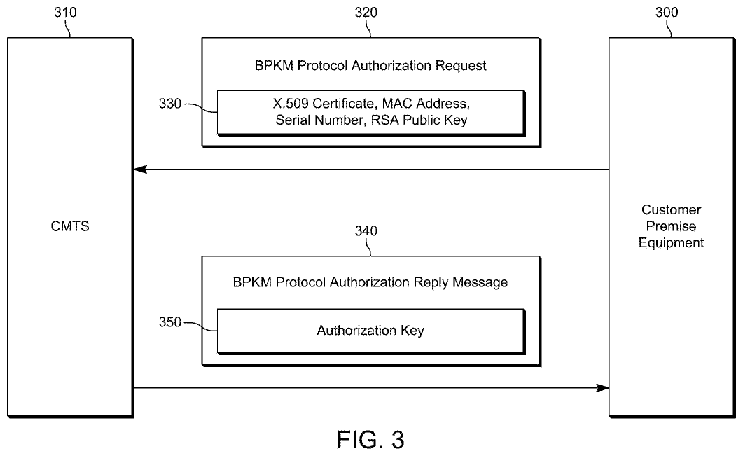

Referring to FIG. 3, customer premise equipment (e.g., cable modem/set top box/etc.) 300 may be authenticated by the CMTS 310 (e.g, D-CMTS/I-CMTS). By way of example, the customer premise equipment 300 may use a baseline privacy key management (BPKM) protocol to send an authorization request 320 that includes a customer premise equipment's identity attribute 330. The identity attribute 330 may be based on an X.509 certificate and a concatenation of a Media Access Control (MAC) address, a serial number, a manufacturer identification, and an Rivest Shamir Adleman (RSA) public key for the customer premise equipment 300. After receiving the authorization request 320, the CMTS 310 authenticates the customer premise equipment 300 by validating the X.509 certificate in the identity attribute 330 using a certificate chain provisioned in the local memory of the CMTS 310. When the customer premise equipment 300 is authorized for cable service the CMTS 310 uses the BPKM protocol to send back an Authorization Reply message 340 that includes a locally generated Authorization Key 350. Lifetime information and ciphersuite information for the Authorization Key 350 are included in the Authorization Reply message 340. Other techniques may be used to authenticate customer premise equipment to make use of the cable network. By way of example, different protocols may be used to authenticate the customer premise equipment. By way of example, an authentication server may be used to authenticate the customer premise equipment. Preferably, the authentication is based upon the DOCSIS 1.0,1.1; 2.0; 3.0; 3.1; and 4.0 protocols. In general, DOCSIS provisioning is based upon the use of back-office systems that are accessible through dynamic host configuration protocol (DHCP). DHCP is defined by RFC 1541 of October 1993 and/or RFC 2131 March 1997, each of which are incorporated by reference herein in their entirety.

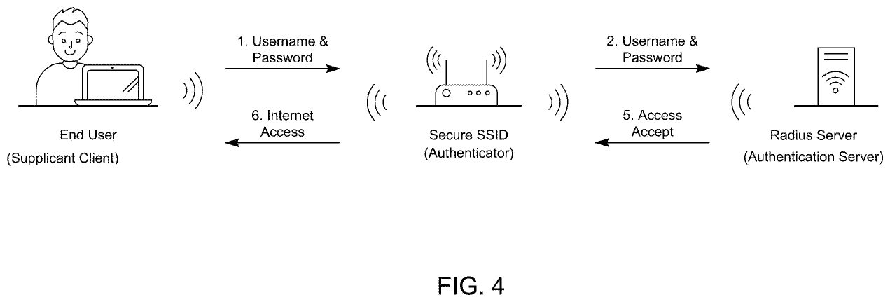

Referring to FIG. 4, other networks, such as when a device is attempting to connect to a LAN or WLAN, may require an authentication mechanism, such as IEEE 802.1X. IEEE 802.1X-2020, Feb. 28, 2020, incorporated by reference herein in its entirety. An 802.1X network includes an authentication serer called a RADIUS Server that checks a user's credentials to see if they are an active member of the organization and, depending on the network policies, grant users varying levels of access to the network. This permits unique credentials or certificates to be used per user, eliminating the reliance on a single network password that can be easily stolen.

The 802.1X is a network authentication protocol that opens ports for network access when an organization authenticates a user's identity and authorizes them for access to the network. The user's identity is determined based on their credentials or certificate, which is confirmed by the RADIUS server, which may communicate with an organization's directory, if desired. The standard authentication protocol used on encrypted networks is Extensible Authentication Protocol (EAP), which provides a secure method to send identifying information for network authentication. 802.1X is the standard that is used for passing EAP over wired and wireless local area networks.

The 802.1X authentication process is comprised of four principal steps, initialization, initiation, negotiation, and authentication. The initialization starts when the authenticator detects a new device and attempts to establish a connection. The authenticator port is set to an “unauthorized” state, meaning that only 802.1X traffic will be accepted and every other connection will be dropped. The initiation includes the authenticator starts transmitting EAP-Requests to the new device, which then sends EAP response back to the authenticator. The response usually contains a way to identify the new device. The authenticator receives the EAP response and relays it to the authentication server in a RADIUS access request packet. The negotiation includes the authentication server receiving the request packet, then it will respond with a RADIUS access challenge packet containing the approved EAP authentication method for the device. The authenticator will then pass on the challenge packet to the device to be authenticated. The authentication includes once the EAP method is configured on the device, the authentication server begins sending configuration profiles so the device will be authenticated. Once the process is complete, the port will be set to “authorized” and the device is configured to the 802.1X network.

The DOCSIS protocol does not include support for 801.1X authentication. Accordingly, a device that is configured to be authenticated based upon 802.1X, such as a voice based handheld phone that is interconnected to the customer premise equipment, is not suitable for being authenticated to the DOCSIS based cable network. It is desirable to facilitate the use of devices on a DOCSIS based network that are authenticated using other techniques, such as IEEE 802.1X, which is a port-based Network Access Control technique. In order to accommodate devices that include data transmitted using a DOCSIS based cable network which are authenticated based upon non-DOCSIS techniques, such as IEEE 802.1X, it is desirable to identify the network traffic that is not authenticated using DOCSIS.

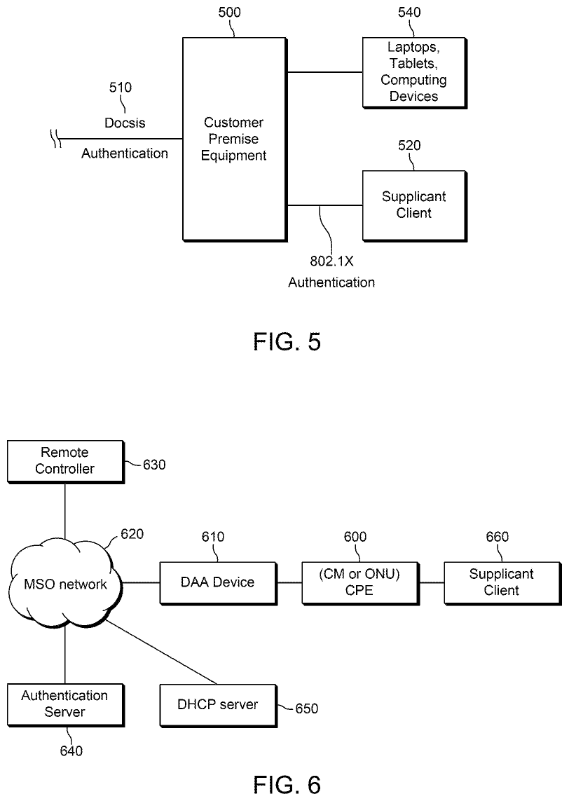

Referring to FIG. 5, the customer premise equipment 500 is interconnected to a DOCSIS based cable network that uses a DOCSIS authentication 510. A supplicant client 520, such as a user device, is interconnected to a port or other connection to the customer premise equipment 500. The supplicant client 520 may be authenticated based upon 802.1X authentication. Other devices, such as laptops, tablets, and other computing devices 540 are likewise authenticated based upon DOCSIS authentication 510. Accordingly, the supplicant client 520 needs to have its data traffic authenticated in a manner different than that which is done for DOCSIS authentication 510. Then once the supplicant client 520 is authenticated, then it is desirable for its data traffic to be transmitted into the cable network in a typical manner. The manner in which the suppliant client 520 is authenticated to the DOCSIS network may be performed using an integrated Cable Modem Termination System and/or distributed Cable Modem Termination System. Also, the network system may be based upon DPoE, which is DOCSIS provisioning of Ethernet Passive Optical Network (EPON), which addresses the management and configuration of data transmission over an EPON system. In general, a DPoE network is comprised of an EPON Optical Line Terminal and Optical Network Units which, for the description herein, are considered to be a CMTS and corresponding cable modems. In general, for DOCSIS and/or DPoE based PON systems, dynamic host protocol servers (DHCP) provides the authorization for customer premise equipment by leasing Internet-Protocol addresses to the requesting consumer premise equipment.

Referring to FIG. 6, an exemplary network architecture is illustrated where a remote controller (e.g., software entity installed on a remote server) performs 802.1X authentication function for supplicant clients that access the network via cable modems/optical network units registered to distributed access devices. The network architecture may include a customer premise equipment (e.g., a cable modem and/or an optical network unit) 600, a distributed access device 610, a multi-service operator network 620, a remote controller 630, an authentication server 640, a DHCP server 650, and/or a supplicant client 660.

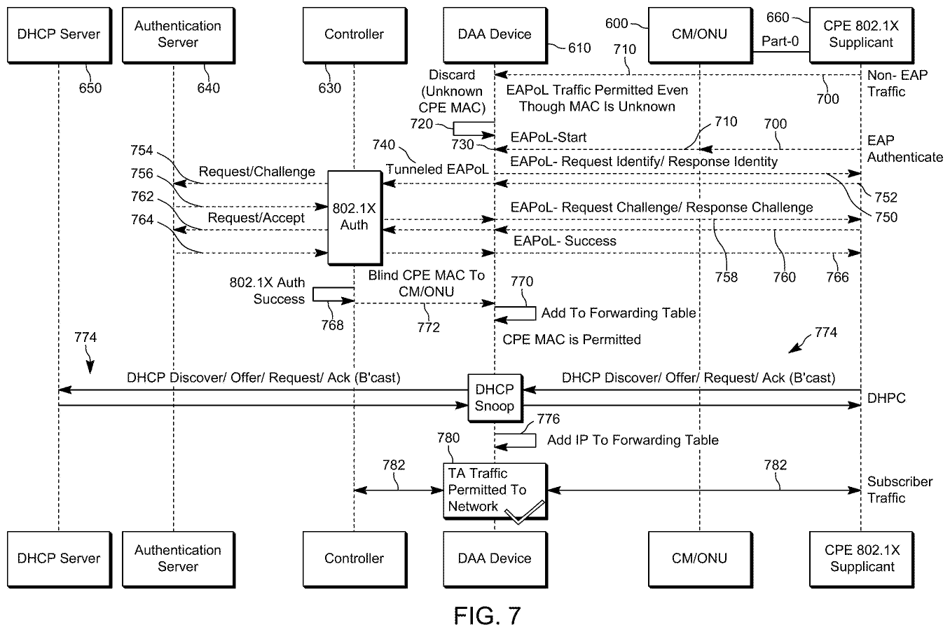

Referring to FIG. 7, the customer premise equipment 600 registers with the MSO network 620 and/or DAA device 610 (e.g., I-CMTS/D-CMTS/OLT) and configuration settings from customer premise equipment configuration files are applied to, the customer premise equipment 600 and the MSO network 620 and/or DAA device 610, to support service flows from the customer premise equipment 600. Configuration settings on the MSO network 620 and/or DAA device 610 indicate whether traffic for each service flow from the customer premise equipment 600 is subject to 802.1X authentication. In particular, in addition to quality-of-service settings, a service class name definition referenced from the customer premise equipment configuration file for each service flow provides a setting (or a pointer to a setting) to enable 802.1X authentication of customer premise equipment 600. This setting (or pointer to the setting) may also be used to specify a unique S-VLAN or Q-VLAN for traffic on that service flow.

The customer premise equipment 600 will forward all upstream traffic 700 from the supplicant client 660, including EAPoL (extensible authentication protocol over LAN) from the customer premise equipment 600, to the service flow 710 configured for 802.1X authentication. The MSO network 620 and/or DAA device 610 will discard 720 all non-EAPol traffic received from the service flow 710.

The MSO network 620 and/or DAA device 610 will process 730 all EAPoL traffic received from the service flow 710. In one approach, the DAA device 610 will tunnel 740 the EAPoL packets to the remote controller 630 for processing. The remote controller 630 performs the 802.1X authenticator role. The remote controller 630 may use a protocol, such as RADIUS, to consult the authentication server 640 to approve the media access control (MAC) address of the supplicant client 660. By way of example, the authentication process may involve, (1) an EAPoL-request identity 750, (2) an EAPoL-response identity 752, (3) a request 754, (4) a challenge 756, (5) an EAPoL-request challenge 758, (6) an EAPoL-response challenge 760, (7) a request 762, (8) an accept 764, and (9) an EAPoL-success 766. As a result, the authentication server 640 may successfully authenticate 768 a supplicant device 660 MAC address.

An 802.1X authenticator (e.g., the remote controller 630 and/or DAA device 610) updates a forwarding table 770 to bind 772 the supplicant client 660 MAC address to the customer premise equipment 600 MAC address, and permit forwarding to and from the supplicant client 660. In this manner, the MAC address of the supplicant device is added to the forwarding table. The supplicant client 660 DHCP traffic 774 (discover/offer/request/acknowledge) is permitted on the network and the supplicant client 660 may obtain an IP address lease from the DHCP server 650. Periodically, the 802.1X authenticator (e.g., the remote controller 630 and/or DAA device 610) may re-authenticate the MAC of the supplicant device 660. The IP address 776 of the suppliant device is added to the forwarding table. The suppliant device 660 is permitted to access the network 780 to send and receive data 782, with its MAC address and IP address of the supplicant client 660 added to the forwarding table.

When the MAC address of the supplicant device 660 is not successfully re-authenticated, the 802.1X authenticator updates the DAA device 610 forwarding table to remove the MAC address binding to the supplicant device 660 and/or to reject forwarding to/from the MAC address of the supplicant device 660.

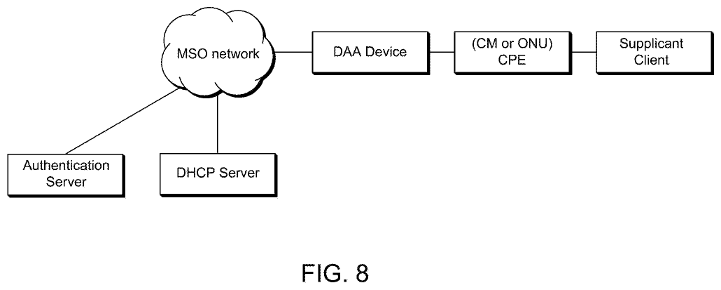

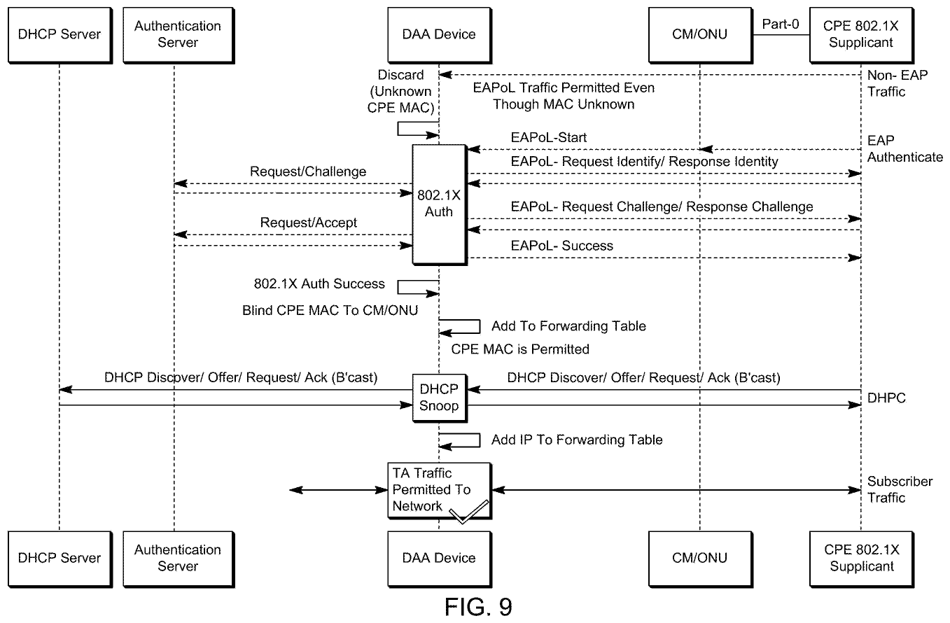

Referring to FIG. 8 and to FIG. 9, another exemplary network architecture is illustrated together with a process description. In the approach shown in FIG. 8 and FIG. 9, the CMTS/OLT may directly process the EAPoL packets and perform the 802.1X authenticator process, by using a protocol, such as RADIUS, to consult the authentication server to approve the media access control (MAC) address of the supplicant client.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A network distribution system comprising:
(a) a customer premise equipment that is authenticated to a network that includes a cable modem termination system based upon a DOCSIS authentication;
(b) said customer premise equipment receives data from a supplicant device that is interconnected to said network through said customer premise equipment where said supplicant device is authenticated to said network based upon an 802.1X authentication.

2. The network distribution system of claim 1 wherein said customer premise equipment receives extensible authentication protocol communication from said supplicant device.

3. The network distribution system of claim 2 wherein said extensible authentication protocol communication is assigned to a service flow configured for 802.1X authentication and provided to said network.

4. The network distribution system of claim 1 wherein said customer premise equipment receives non-extensible authentication protocol communication from said supplicant device.

5. The network distribution system of claim 4 wherein said non-extensible authentication protocol communication is assigned to a service flow configured for 802.1X authentication and provided to a distributed access device which discards said non-extensible authentication protocol communication.

6. The network distribution system of claim 4 wherein said non-extensible authentication protocol communication is assigned to a service flow configured for 802.1X authentication and provided to said cable modem termination system which discards said non-extensible authentication protocol communication.

7. The network distribution system of claim 3 wherein said extensible authentication protocol communication is provided on said service flow to at least one of a DAA device and said cable modem termination system.

8. The network distribution system of claim 7 wherein said extensible authentication protocol communication is tunneled from said DAA device to a controller.

9. The network distribution system of claim 8 wherein said controller performs 802.1X authentication for said supplicant device.

10. The network distribution system of claim 9 wherein said controller consults an authentication server to approve a media access control (MAC) address of said supplicant device.

11. The network distribution system of claim 10 wherein said 802.1X authentication includes an EAPoL-request identity, an EAPoL-response identity, a request, a challenge, an EAPoL-request challenge, an EAPoL-response challenge, a request, an accept, and an EAPoL-success.

12. The network distribution system of claim 10 wherein a forwarding table is updated to include said media access control (MAC) address of said supplicant device.

13. The network distribution system of claim 12 wherein said forwarding table binds said media access control (MAC) address to said customer premise equipment.

14. The network distribution system of claim 13 wherein a dynamic host configuration protocol server provides an IP address to said supplicant client in response to a request from said supplicant client.

15. The network distribution system of claim 14 wherein said forwarding table is updated to include said IP address of said supplicant device.

16. A networking system comprising:
(a) a customer premise equipment that is authenticated to a network that includes a cable modem termination system based upon a DOCSIS authentication;
(b) said customer premise equipment receives data from an interconnected device to a port of said customer premise equipment that is interconnected to said network through said customer premise equipment where said interconnected device is authenticated to said network based upon an authentication different than said DOCSIS authentication.

17. A networking system comprising:
(a) a customer premise equipment that is authenticated to a network that includes a cable modem termination system based upon a first non-port based authentication technique;
(b) said customer premise equipment receives data from an interconnected device to a port of said customer premise equipment that is interconnected to said network through said customer premise equipment where said interconnected device is authenticated to said network based upon a port based authentication technique that is different than said first authentication.
